(19) United States
(12) Patent Application Publication
(10) Pub. No.: US 2026/0182675 A1
(43) Pub. Date: Jul. 2, 2026

(54) AEROSOL PROVISION SYSTEM

(71) Applicant: Nicoventures Trading Limited, London (GB)

(72) Inventors: Dean COWAN, London (GB); Hanliang CHEN, Guangdong (CN); Chi Wai FUNG, Guangdong (CN); Dongyang LIN, Guangdong (CN)

(21) Appl. No.: 19/130,403

(22) PCT Filed: Nov. 24, 2023
(86) PCT No.: PCT/EP2023/083074

§ 371 Date: May 15, 2025

(30) Foreign Application Priority Data
Nov. 25, 2022 (CN) 2022114902320
Feb. 15, 2023 (GB) 2302167.8

(51) Int. Cl. A24F 40/95; A24F 40/53; A24F 40/65; H02J 7/40; H02J 7/60; H02J 7/70; H02J 7/82

(52) U.S. Cl. CPC A24F 40/95; A24F 40/53; A24F 40/65; H02J 7/40; H02J 7/663; H02J 7/731; H02J 7/825

(57) ABSTRACT

An aerosol provision system comprises an aerosol provision device and a charging unit for charging the aerosol provision device, wherein the aerosol provision device comprises an aerosol generator, the aerosol generator configured to generate an aerosol from aerosol generating material, wherein the charging unit comprises: a receptacle for receiving the aerosol provision device; a cover moveable between an open position and a closed position, the cover configured to cover at least a portion of the aerosol provision device when the cover is in the closed position; and a charging unit controller configured to periodically send a heartbeat communication to the aerosol provision device, wherein the heartbeat communication comprises a cover status, the cover status indicative of whether the cover is in the open position or in the closed position.

### CROSS-REFERENCE TO RELATED APPLICATIONS

This present application is a National Phase entry of PCT Application No. PCT/EP2023/083074, filed 24 Nov. 2023, which claims priority from Great Britain Application No. 2302167.8, filed 15 Feb. 2023, and Chinese Application No. 2022114902320, filed 25 Nov. 2022, each of which are fully incorporated herein by reference in their entireties.

### TECHNICAL FIELD

The present invention relates to an aerosol provision system, an aerosol provision device, a charging unit and a method.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

### SUMMARY

According to a first aspect, an aerosol provision system comprising an aerosol provision device and a charging unit for charging the aerosol provision device is provided, wherein the aerosol provision device comprises an aerosol generator, the aerosol generator configured to generate an aerosol from aerosol generating material,
wherein the charging unit comprises:
a receptacle for receiving the aerosol provision device;
a cover moveable between an open position and a closed position, the cover configured to cover at least a portion of the aerosol provision device when the cover is in the closed position; and
a charging unit controller configured to periodically send a heartbeat communication to the aerosol provision device, wherein the heartbeat communication comprises a cover status, the cover status indicative of whether the cover is in the open position or in the closed position.

The charging unit controller may be configured to send the heartbeat communication with a heartbeat period, wherein the heartbeat period is less than 1 s.

The heartbeat period may be approximately 200 ms.

The aerosol provision device may comprise a device controller, the device controller configured to receive the heartbeat communication and to send a heartbeat back communication to the charging unit controller in response to receiving the heartbeat communication.

The heartbeat back communication may comprise aerosol delivery device status information.

The aerosol provision device may comprise a device energy storage, the aerosol delivery device status information comprising a charge level of the device energy storage.

The heartbeat back communication may comprise a command.

The command may be to display a charge level of the charging unit energy storage, or the command is to shut down the charging unit.

The command may be to shut down the charging unit.

A user input element may be provided, the aerosol provision device may comprise a device controller configured to control the aerosol provision device to enter an off state in response to the user providing an input to the user input element and the cover being in the closed position.

Activation of the aerosol generator may be prevented when the aerosol provision device is in the off state.

The aerosol provision system may comprise a controller configured to prevent activation of the aerosol generator when the cover is in the closed position.

The aerosol provision device may be a tobacco heating product.

According to a second aspect, a charging unit for charging an aerosol provision device is provided, the aerosol provision device comprising an aerosol generator, the aerosol generator configured to generate an aerosol from aerosol generating material, the charging unit comprising:
a receptacle for receiving the aerosol provision device;
a cover moveable between an open position and a closed position, the cover configured to cover at least a portion of the aerosol provision device when the cover is in the closed position; and
a charging unit controller configured to periodically send a heartbeat communication to the aerosol provision device, wherein the heartbeat communication comprises a cover status, the cover status indicative of whether the cover is in the open position or in the closed position.

The charging unit controller may be configured to send the heartbeat communication with a heartbeat period, wherein the heartbeat period is less than 1 s.

The heartbeat period may be approximately 200 ms.

The charging unit controller may be configured to receive a heartbeat back communication from a device controller in the aerosol in response to the device controller receiving the heartbeat communication.

The heartbeat back communication may comprise aerosol delivery device status information.

The aerosol provision device may comprise a device energy storage, the aerosol delivery device status information comprising a charge level of the device energy storage.

The heartbeat back communication may comprise a command.

The command may be to display a charge level of the charging unit energy storage.

The command may be to shut down the charging unit.

According a third aspect, there is provided a method of operating a charging unit for an aerosol provision device, the aerosol provision device comprising an aerosol generator, the aerosol generator configured to generate an aerosol from aerosol generating material, the charging unit comprising:
a receptacle for receiving the aerosol provision device;
a cover moveable between an open position and a closed position, the cover configured to cover at least a portion of the aerosol provision device when the cover is in the closed position,
the method comprising periodically sending a heartbeat communication to the aerosol provision device, wherein the heartbeat communication comprises a cover status, the cover status indicative of whether the cover is in the open position or in the closed position.

According to a fourth aspect, there is provided an aerosol provision system comprising:
an aerosol provision device comprising an aerosol generator, a device controller and a device energy storage, the aerosol generator configured to generate aerosol from an aerosol generating material;
a charging unit for charging the aerosol provision device, the charging unit comprising:
a receptacle for receiving the aerosol provision device; and
a cover moveable between an open position and a closed position, the cover configured to cover at least a portion of the aerosol provision device when the cover is in the closed position; and
a controller configured to prevent activation of the aerosol generator when the cover is in the closed position.

The controller may be a device controller of the aerosol provision device.

The charging unit may comprise a charging unit controller configured to send a cover closed signal to the device controller.

The charging unit controller may be configured to periodically send a heartbeat communication to the aerosol provision device, wherein the heartbeat communication comprises a cover closed signal when the cover is in the closed position.

The aerosol provision device may comprise a memory and the device controller is configured to, in response to receiving the cover closed signal, store a cover closed indicator in the memory.

The device controller may be configured to, in response to the device controller receiving an aerosol generator activation signal and the cover being in the open position, determine a charge level of a charging unit energy storage.

In response to the charging unit energy storage having a charge level above a charging unit activation threshold, the device controller may be configured to activate the aerosol generator by supplying energy from the charging unit energy storage to the aerosol generator.

In response to the aerosol delivery device being disconnected from the charging unit during an aerosol generating session in which energy is being supplied from the charging unit energy storage to the aerosol generator, the device controller may be configured to supply energy from a device energy storage to the aerosol generator.

In response to the charging unit energy storage having a charge level below the charging unit activation threshold, the device controller may be configured to activate the aerosol generator by supplying energy from the device energy storage to the aerosol generator.

The aerosol provision device may be a tobacco heating product.

The charging unit may comprise a cover position sensor to determine whether the charging unit is in the open position or the closed position.

The cover position sensor may be a hall sensor.

The cover may be slidable between the open position and the closed position.

In the closed position the cover may cover an opening of the aerosol provision device, the opening configured to receive an article comprising the aerosol generating material therethrough.

The system may comprise an article comprising the aerosol generating material, the article received in the aerosol provision device.

According to a fifth aspect, there is provided an aerosol provision device comprising:
a device controller; and
an aerosol generator configured to generate an aerosol from an aerosol generating material,
wherein the device controller is configured to:
   receive a cover closed signal, the cover closed signal indicating that a cover of a charging unit connected to the aerosol provision device is in a closed position; and
   in response to receiving the cover closed signal, prevent activation of the aerosol generator.

The controller may be a device controller of the aerosol provision device.

The aerosol provision device may comprise a memory and the device controller is configured to, in response to receiving the cover closed signal, store a cover closed indicator in the memory.

The device controller may be configured to, in response to the device controller receiving an aerosol generator activation signal and the cover being in the closed position, determine a charge level of a charging unit energy storage.

In response to the charging unit energy storage having a charge level above a charging unit activation threshold, the device controller may be configured to activate the aerosol generator by supplying energy from the charging unit energy storage to the aerosol generator.

In response to the aerosol delivery device being disconnected from the charging unit during an aerosol generating session in which energy is being supplied from the charging unit energy storage to the aerosol generator, the device controller may be configured to supply energy from a device energy storage to the aerosol generator.

In response to the charging unit energy storage having a charge level below the charging unit activation threshold, the device controller may be configured to activate the aerosol generator by supplying energy from the device energy storage to the aerosol generator.

The aerosol provision device may be a tobacco heating product.

The aerosol provision device may further comprise an article comprising the aerosol generating material, the article received in the aerosol provision device.

According to a sixth aspect, there is provided a method of operating an aerosol provision system, the aerosol provision system comprising an aerosol provision device comprising an aerosol generator, a device controller and a device energy storage, the aerosol generator configured to generate aerosol from an aerosol generating material and a charging unit for charging the aerosol provision device, the charging unit comprising:
a receptacle for receiving the aerosol provision device; and
a cover moveable between an open position and a closed position, the cover configured to cover at least a portion of the aerosol provision device when the cover is in the closed position; and
a controller,
the method comprising the controller preventing activation of the aerosol generator when the cover is in the closed position.

According to a seventh aspect, there is provided an aerosol provision system comprising:
an aerosol provision device comprising an aerosol generator and a device controller, the device controller configured to control the aerosol generator to generate an aerosol from aerosol generating material;
a charging unit for charging the aerosol provision device, the charging unit comprising:
a receptacle for receiving the aerosol provision device; and
a cover moveable between an open position and a closed position, the cover configured to cover at least a portion of the aerosol provision device when the cover is in the closed position; and
a user input element, wherein the device controller is configured to control the aerosol provision device to enter an off state in response to the user providing an input to the user input element and the cover being in the closed position.

The aerosol provision device may comprise the user input element.

The aerosol provision device may be configured to remain in the off state when the cover is moved to the open position.

Activation of the aerosol generator may be prevented when the aerosol provision device is in the off state.

The aerosol provision device may comprise a device energy storage, wherein charging of the device energy storage is permitted when the aerosol provision device is in the off state.

The aerosol provision device may be configured to exit the off state in response to the user providing an additional input to the user input element.

The charging unit may be configured to enter an off state in response to the user providing the input to the user input element.

The device controller may be configured to receive a heartbeat communication.

The heartbeat communication may comprise a cover status, the cover status indicative of whether the cover is in the open position or in the closed position.

According to an eighth aspect, there is provided an aerosol provision device comprising:
a device controller; and
an aerosol generator configured to generate an aerosol from an aerosol generating material,
wherein the device controller is configured to:
receive a cover closed signal, the cover closed signal indicating that a cover of a charging unit connected to the aerosol provision device is in a closed position;
receive a user input signal, the user input signal indicating that a user has actuated a user input element; and
in response to receiving the cover closed signal and the user input signal, control the aerosol provision device to enter an off state.

The aerosol provision device may comprise the user input element.

The aerosol provision device may be configured to remain in the off state when the cover is moved to the open position.

Activation of the aerosol generator may be prevented when the aerosol provision device is in the off state.

The aerosol provision device may comprise a device energy storage, wherein charging of the device energy storage is permitted when the aerosol provision device is in the off state.

The aerosol provision device may be configured to exit the off state in response to the user providing an additional input to the user input element.

The charging unit may be configured to enter an off state in response to the user providing the input to the user input element.

In accordance with a ninth aspect, there is provided a method of operating an aerosol provision system, the aerosol provision system comprising an aerosol provision device and a charging unit, the aerosol provision device comprising an aerosol generator configured to control the aerosol generator to generate an aerosol from aerosol generating material, the charging unit comprising:
a receptacle for receiving the aerosol provision device; and
a cover moveable between an open position and a closed position, the cover configured to cover at least a portion of the aerosol provision device when the cover is in the closed position; and
a user input element,
the method comprising controlling the aerosol provision device to enter an off state in response to the user providing an input to the user input element and the cover being in the closed position.

According to a tenth aspect, there is provided an aerosol provision system comprising an aerosol provision device and a charging unit for charging the aerosol provision device, wherein the aerosol provision device comprises an aerosol generator, the aerosol generator configured to generate an aerosol from aerosol generating material,
wherein the charging unit comprises:
a charging unit controller configured to periodically send a heartbeat communication to the aerosol provision device, wherein the heartbeat communication comprises information relating to the charging unit and/or the aerosol provision device.

According to an eleventh aspect, a charging unit for charging an aerosol provision device is provided, the aerosol provision device comprising an aerosol generator, the aerosol generator configured to generate an aerosol from aerosol generating material, the charging unit comprising:
a charging unit controller configured to periodically send a heartbeat communication to the aerosol provision device, wherein the heartbeat communication comprises information relating to the charging unit and/or the aerosol provision device.

According to a twelfth aspect, there is provided a method of operating a charging unit for an aerosol provision device, the aerosol provision device comprising an aerosol generator, the aerosol generator configured to generate an aerosol from aerosol generating material,
the method comprising periodically sending a heartbeat communication to the aerosol provision device, wherein the heartbeat communication comprises information relating to the charging unit and/or the aerosol provision device.

According to a thirteenth aspect, there is provided an aerosol provision device comprising:
a device controller; and
an aerosol generator configured to generate an aerosol from an aerosol generating material,
wherein the device controller is configured to send a heartbeat communication to a charging unit, wherein the heartbeat communication comprises information relating to the charging unit and/or the aerosol provision device.

Any of the optional features specified above may be included in a system according to the first, fourth, seventh and/or tenth aspect, a charging unit according to the second and/or eleventh aspect, a device according to the fifth, eight and/or thirteenth aspect and/or a method according to the third, sixth, ninth and/or twelfth aspect.

### BRIEF DESCRIPTION OF THE DRAWINGS

Various embodiments will now be described, by way of example only, and with reference to the accompanying drawings, in which:

FIG. 1 shows an aerosol provision system comprising an aerosol provision device located within a charging unit;

FIG. 2 shows a flow chart illustrating various modes of operation of an aerosol provision device and a charging unit according to embodiments; and

FIG. 3 shows a schematic diagram of a heartbeat communication between an aerosol provision device and a charging unit.

### DETAILED DESCRIPTION

According to the present disclosure, a “non-combustible” aerosol provision system is one where a constituent aerosol generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol generating material is not a requirement.

In some embodiments, the non-combustible aerosol provision system is an aerosol generating material heating system, also known as a heat-not-burn system. An example of such a system is a tobacco heating system.

In some embodiments, the non-combustible aerosol provision system is a hybrid system to generate aerosol using a combination of aerosol generating materials, one or a plurality of which may be heated. Each of the aerosol generating materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol generating material, an aerosol generating material storage area, an aerosol generating material transfer component, an aerosol generator, an aerosol generation area, a housing, a wrapper, a filter, a mouthpiece, and/or an aerosol-modifying agent.

Aerosol generating material is a material that is capable of generating aerosol, for example when heated, irradiated or energized in any other way. Aerosol generating material may, for example, be in the form of a solid, liquid or semi-solid (such as a gel) which may or may not contain an active substance and/or flavourants.

The aerosol generating material may comprise a binder and an aerosol former. Optionally, an active and/or filler may also be present. Optionally, a solvent, such as water, is also present and one or more other components of the aerosol generating material may or may not be soluble in the solvent. In some embodiments, the aerosol generating material is substantially free from botanical material. In particular, in some embodiments, the aerosol generating material is substantially tobacco free.

The aerosol generating material may comprise or be an aerosol generating film. The aerosol generating film may be formed by combining a binder, such as a gelling agent, with a solvent, such as water, an aerosol-former and one or more other components, such as active substances, to form a slurry and then heating the slurry to volatilise at least some of the solvent to form the aerosol generating film.

The slurry may be heated to remove at least about 60 wt %, 70 wt %, 80 wt %, 85 wt % or 90 wt % of the solvent. The aerosol generating film may be a continuous film or a discontinuous film, such an arrangement of discrete portions of film on a support. The aerosol generating film may be substantially tobacco free.

The aerosol generating film may comprise or be a sheet, which may optionally be shredded to form a shredded sheet.

The aerosol generating material may comprise one or more active substances and/or flavours, one or more aerosol-former materials, and optionally one or more other functional material.

An aerosol generator is an apparatus configured to cause aerosol to be generated from the aerosol generating material. In some embodiments, the aerosol generator is a heater configured to subject the aerosol generating material to heat energy, so as to release one or more volatiles from the aerosol generating material to form an aerosol. In some embodiments, the aerosol generator is configured to cause an aerosol to be generated from the aerosol generating material without heating. For example, the aerosol generator may be configured to subject the aerosol generating material to one or more of vibration, increased pressure, or electrostatic energy.

A consumable is an article comprising or consisting of aerosol generating material, part or all of which is intended to be consumed during use by a user. A consumable may comprise one or more other components, such as an aerosol generating material storage area, an aerosol generating material transfer component, an aerosol generation area, a housing, a wrapper, a mouthpiece, a filter and/or an aerosol-modifying agent. A consumable may also comprise an aerosol generator, such as a heater, that emits heat to cause the aerosol generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents and when such eddy currents are generated in the object, their flow against the electrical resistance of the object causes the object to be heated. This process is called Joule, ohmic or resistive heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

Various embodiments will now be described in more detail.

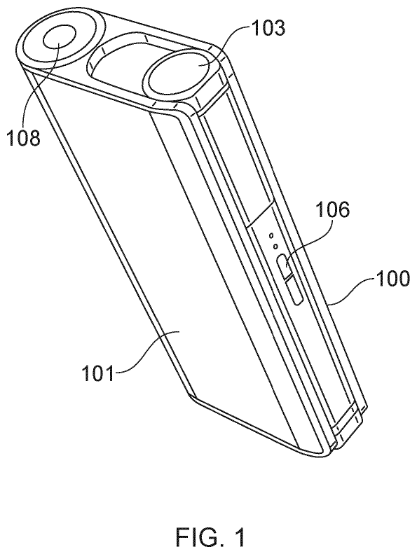

FIG. 1 shows an aerosol provision system comprising an aerosol provision device 100 which is shown inserted within a receptacle of a charging unit 101. The aerosol provision device 100 is arranged to generate aerosol from an aerosol generating article or consumable (not shown) which may be inserted, in use, into the aerosol provision device 100.

The aerosol provision device 100 may comprise an elongate structure which extends along a longitudinal axis. The aerosol provision device 100 has a proximal end, which is closest to the user (e.g. the user's mouth) when in use by the user to inhale the aerosol generated by the aerosol provision device 100. The aerosol provision device 100 further comprises a distal end which will be furthest from the user when in use. The proximal end may also be referred to as the mouth end. The aerosol provision device 100 also accordingly defines a proximal direction which is directed towards the user when in use i.e. in the direction from the distal end to the proximal end. Further, the aerosol provision device 100 also likewise defines a distal direction which is directed away from the user when in use i.e. in the direction from the proximal end to the distal end.

The aerosol provision device 100 may be removably inserted into the charging unit 101 in order to be charged. The charging unit 101 comprises a receptacle for receiving the aerosol provision device 100. The aerosol provision device 100 may be inserted into the receptacle via an opening. The receptacle may also comprise a longitudinal opening. A portion of the aerosol provision device 100 may comprise a first side. One or more user input elements such as buttons 106 which can be used to operate the aerosol provision device 100 may be provided on the first side of the aerosol provision device 100. The first side of the aerosol provision device 100 may be received within the longitudinal opening provided in the charging unit 101.

The receptacle of the charging unit 101 may have a cross-sectional profile which only permits the aerosol provision device 100 to be inserted into the charging unit 101 in a single particular orientation. The outer profile of the aerosol provision device 100 may comprise an arcuate portion and a linear portion. The cross-sectional profile of the receptacle provided in the charging unit 101 may also comprise a similar arcuate portion and a linear portion. The linear portion of the cross-sectional profile of the receptacle may correspond with the longitudinal opening.

The aerosol provision device 100 comprises an opening leading into a heating chamber. A rod shaped aerosol generating article comprising aerosol generating material may be inserted through the opening and may be retained within the heating chamber of the aerosol provision device 100. The aerosol generating article may be heated by a heating element so that an aerosol or other inhalable medium may be generated which may then be inhaled by a user of the aerosol provision device 100.

The charging unit 101 may include a slidable cover 103. The slidable cover 103 is moveable between an open position and a closed position.

When the aerosol provision device 100 is inserted into the charging unit 101 in order to be recharged, in the closed position (shown in FIG. 1) the slidable cover 103 covers the opening into the aerosol provision device 100. The opening in the aerosol device is configured to receive an article comprising aerosol generating material therethrough. In the open position (not shown), the slidable cover 103 does not cover the opening of the aerosol provision device 100.

When the cover 103 is in the open position, the aerosol provision device 100 is secured in the receptacle of the charging unit 101 and, as such, is not easily removable or likely to fall out of the receptacle of the charging unit 101.

The charging unit 101 may include a user interface such as display 108.

The charging unit 101 may comprise a user input element. The user input element may be arranged as part of display 108. Alternatively, or additionally, the user input element may be a button or a switch arranged on the charging unit. It will be understood that any suitable user input element may be provided that allows the user to provide an input.

The charging unit 101 comprises a charging unit controller (not shown) which is configured to control various aspects of the charging unit 101. In particular, the charging unit controller located within the charging unit 101 may be arranged to control an electrical energy storage device of the charging unit 101. The electrical energy storage device may comprise, for example, a battery. The controller located within charging unit 101 may comprise a central processing unit (CPU), a microprocessor or a microcontroller (MCU).

The battery of the charging unit 101 may comprise a lithium cobalt oxide (LiCoO₂) battery, a lithium manganese oxide (LiMn₂O₄) battery, a lithium nickel manganese cobalt oxide (LiNiₓMn_{y}CO_{z}O₂) battery or a lithium nickel cobalt aluminium oxide (LiNiCoAlO₂) battery. The battery may have a capacity≥1000 mAh.

The aerosol provision device 100 may also comprise a device controller (not shown) which is configured to control various aspects of the aerosol provision device 100. In particular, the device controller located within the aerosol provision device 100 may be configured to control an electrical energy source of the aerosol provision device 100. The device controller may control the aerosol provision device 1000 to enter an on state, wherein the electrical energy source energises the aerosol generator. The device controller may control the aerosol provision device 100 to enter an off state, wherein the electrical energy source is turned off and does not energise the aerosol generator. The controller may comprise a central processing unit (CPU), a microprocessor or a microcontroller (MCU). The electrical energy storage device may comprise a battery. For example, the battery of the aerosol provision device 100 may comprise a lithium iron phosphate (LiFePO₄) battery or a lithium titanate or lithium titanium oxide (LTO) battery. The battery may have a capacity≤200 mAh.

The respective controllers of the charging unit 101 and aerosol provision device 100 may be arranged to communicate with each other when the aerosol provision device 100 is electrically connected to the charging unit 101 i.e. when the aerosol provision device 100 is inserted into or docked within the charging unit 101.

It is also contemplated that the respective controllers may be arranged so as to communicate wirelessly with each other when the aerosol provision device 100 is remote from the charging unit 101. Wireless communication can be enabled by wireless fidelity (WiFi), Bluetooth, any other suitable wireless local area network (WLAN), wireless personal area network (WPAN) or wireless sensor actor network (WSAN) protocols.

The controller located within the charging unit 101 (charging unit controller) may be arranged to send communications to the device controller of the aerosol provision device 100. The device controller may be arranged to receive communications form the charging unit controller. The device controller may be arranged to send communications to the charging unit controller. The device controller may send a back communication in response to receiving a communication from the charging unit controller. The charging unit controller may be used to receive communications from the device controller of the aerosol provision device.

The charging unit controller and/or the device controller may be arranged to send communication information on the status of the slidable cover 103. Information on the status of the slidable cover 103 may include whether it is in the open or closed position.

The charging unit controller may be arranged to prevent activation of the aerosol generator when the slidable cover 103 is in the closed position. Alternatively, the device controller of the aerosol provision device 100 may be arranged to prevent activation of the aerosol generator when the slidable cover 103 is in the closed position.

The device controller may be configured to control the aerosol provision device 100 to enter an off state in response to a user providing an input to a user input element on the aerosol provision device 100. In response to a user providing an input to the user input element, the device controller is arranged to control the aerosol provision device to enter an off state. This may happen in reverse if the aerosol provision device is already in an off state and in response to a user providing an input to a user input element on the aerosol provision device 100, the device controller may be arranged to control the aerosol provision device to enter an on state.

It will be understood that a user may input into a user input element on the charging unit. The user input will be communicated to the charging unit controller which subsequently communicates with the device controller to control the aerosol provision device to enter an off state. It will be understood that this may work in the opposite direction. For example a user input may cause the device to enter an on state where it is ready for a session of use to commence.

Details of the operation of the aerosol provision device 100 and the charging unit 101 in use are described in more detail herein.

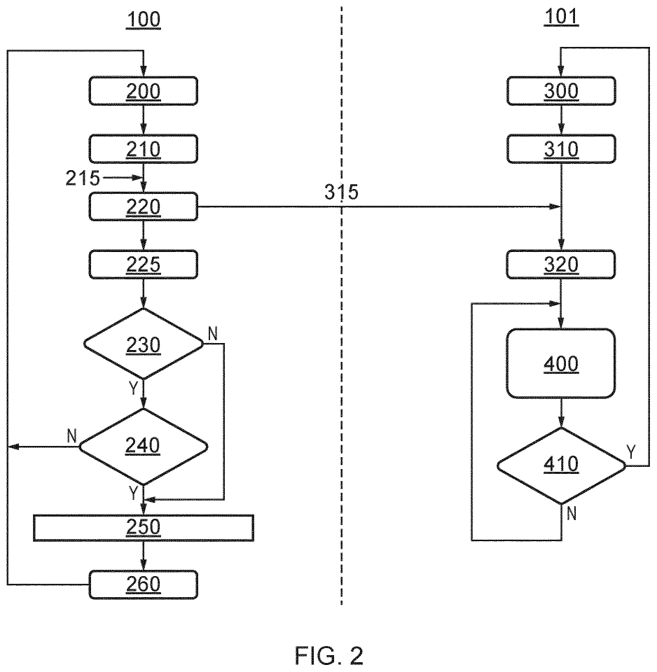

FIG. 2 shows a flow chart illustrating modes of operation of an aerosol provision device according to various embodiments. In particular, FIG. 2 illustrates aspects of the controller logic as used by the controllers of the aerosol provision device 100 and the charging unit 101.

The controller of the aerosol provision device 100 may operate initially in an idle state 200. The idle state 200 corresponds to a situation where the aerosol provision device 100 is in a standby mode, i.e. where the device is in an “on” state from the perspective of the user, but where no session of use is commenced and there is no user input.

The sleep state 310 corresponds to the device being effectively turned “off”. The aerosol provision device 100 may enter a low power mode while in the sleep state 210. As such, power may be provided to fewer components of the aerosol provision device in the sleep state than in the idle state.

The aerosol provision device 100 may enter the sleep state 210 when the user provides a user input to the device 100 so that it is turned completely off. For example, the sleep state may be suitable for conditions like air travel where the device 100 but be turned off completely.

The sleep state 210 may require the aerosol provision device 100 to be inserted into the charging unit 101 and for the cover 103 to be in the closed position. The required user input to the device may be to press and hold the user input element on the aerosol provision device 100.

In embodiments, the aerosol provision device 100 may enter a sleep state 210 when the device 100 has remained in the idle state for over a predetermined amount of time with no session of use being commenced and no user input.

When the aerosol provision device 100 is in the sleep state 210 or idle state 200 and a user input 215 is received by the device controller of the aerosol provision device 100, the aerosol provision device 100 controller enters a wake-up state 220. Entering the wake-up state 220 may occur when a user activates one or more of the user input elements 106 of the aerosol provision device 100. The user input elements may be buttons 106. In embodiments, entering the wake-up state may occur when the cover 103 is moved to the open position. In embodiments, entering the wake-up state may occur when the aerosol provision device 100 is removed from the charging unit 101.1 In the wake-up state 230, the device controller establishes a connection 315 with the charging unit controller of the charging unit 101 to enable communications to be sent.

The charging unit controller may initially be in an idle state 300 or a sleep state 310. The idle state 300 corresponds to a situation where the charging unit controller being turned on but where no user input or session of use is commenced. The sleep state 310 corresponds to a situation where the charging unit controller is turned off in response to a user input from a user and the aerosol provision device 100 is inserted into the charging unit 101 and the cover is in the closed position.

In response to the communication from the device controller establishing a connection 315 with the charging unit controller, the charging unit controller enters a corresponding wake-up state 320 from the controller idle state 310.

The user may then provide a further input 225 to one or more of the user input elements 106. In an embodiment, the user may press the button 106 a second time. In an embodiment, the first user input 215 may correspond to pressing the button 106 down, while the further user input 225 may correspond to a user releasing the pressed button 106. In embodiments, the duration of the wake up state 220 of the device may only be a short period of time, for example three seconds, which corresponds to a user holding down the button 106 for three or more seconds.

In the device wake up state, the device controller may determine whether the aerosol provision device 100 is inserted into receptacle the charging unit 101.

If it is determined that the aerosol provision device is not inserted into the receptacle of the charging unit 101, the device may proceed to start a session of use 250. The session may be initiated automatically once the determination has been made and following the earlier user input 225. In an embodiment, the session of use may only be initiated following a further user input, for example pressing the button 106 again.

If it is determined that the aerosol provision device is inserted into the receptacle of the charging unit 101, a further determination 240 will be made regarding the position of the cover 103.

The charging unit 101 may comprise a cover position sensor to allow the charging unit controller to determine whether the slidable cover 103 is in the open or closed position. The cover position sensor may be a hall sensor. The hall sensor may be used to assess the proximity of an end of the slidable cover to determine whether the cover 103 is in the open or closed position. It will be understood that other appropriate sensors, such as mechanical sensors or light sensors, may be used in place of the hall sensor to make the same determination.

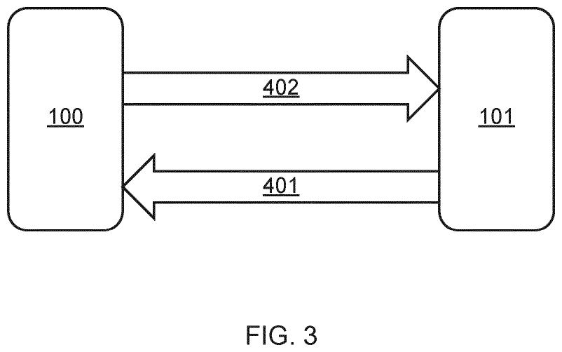

As described by way of example in more detail below with respect to FIG. 3, the charging unit controller sends a communication to the device controller comprising the cover status. The cover status is indicative of whether the cover 103 is in the open or closed position. The device controller receives a communication from the charging unit controller that indicates whether the cover 103 of the charging unit is in the open or closed position.

In embodiments, the communication to the device controller may comprise information relating to the charging unit 101 and/or the aerosol provision device. The communication may comprise information relating to, for example, the charging status of the aerosol provision device 100 and/or the charging unit 101. The communication may comprise information relating to aerosol delivery device status. The communication may comprise information relating to the progress of a session of use. In embodiments, the communication may comprise information relating to the charging unit 101 and/or the aerosol provision device in addition to comprising the cover status. In embodiments, the heartbeat communication may comprise information relating to the charging unit 101 and/or the aerosol provision device without the cover status.

In an embodiment, in response to the device controller receiving a communication indicating that the cover 103 is in the closed position, the device controller of the aerosol provision device 100 will not control the aerosol generator to activate. The controller of the aerosol provision device 100 will revert back to the idle state.

In an embodiment, in response to the device controller receiving a communication indicating that the cover 103 is in the open position, the device controller of the aerosol provision device will activate the aerosol generator to commence a session of use 250.

The communications sent by the charging unit to the device controller may be heartbeat communications. FIG. 3 shows a simplified schematic drawing of the heartbeat communication process.

The charging unit 101 controller is configured to send a heartbeat communication 400 to the device 100 controller periodically and consistently. The heartbeat communication 400 is sent in a heartbeat period. Each heartbeat period comprises sending the communication 400 to the device controller immediately followed by a period of no communication with the device controller. In an embodiment, the heartbeat period may be less than 1 second. In an embodiment, the heartbeat period may be approximately 200 ms. This corresponds to each communication being sent from the charging unit controller to the device controller at a frequency of one communication each 200 ms.

Once the device controller of the aerosol provision device 100 has received the heartbeat communication 400, the device controller is arranged to send a heartbeat back communication 401 to the charging unit controller in response to receiving the heartbeat communication 400.

The heartbeat back communication 401 may comprises information relating to aerosol delivery device status 410. If a session of use is in progress, the device controller will communicate the aerosol is being delivered to a user. The charging unit controller determines that the heartbeat communications 400 should continue to be sent to the device controller. As such, sending the communication 400 to the device controller is repeated.

In an embodiment, the device controller is arranged to control the aerosol provision device 100 to enter an the idle state 200 in response to the device controller receiving a communication indicting that the cover 103 is in a closed position and/or a user providing an input to the user input element, i.e. buttons 106. In an embodiment, the aerosol provision device is configured to remain in the idle state 100 in response to the slidable cover 103 being moved to the open position.

In an embodiment, the device controller is arranged to control the aerosol provision device 100 to entre the sleep state 210 in response to the device controller receiving a communication indicating that the cover 103 is in a closed position and a user providing a further input to the user input element 106. For example, the further user input may be to press and hold the user input element 106.

If the session of use is not in progress, for example if the device controller has entered the idle state, this information will be contained in the heartbeat back communication that will be received by the charging unit controller. In response to this, the charging unit controller will enter the idle state 300.

In an embodiment, the heartbeat back communication 401 may comprise information relating to status of the aerosol provision device 100, such as idle, wake-up, session of use commenced. In an embodiment, the heartbeat back communication 401 may comprise information on the battery level of the aerosol provision device.

In an embodiment, the heartbeat back communication 401 may comprise a command. The command may be in addition to or as an alternative to information. The command may be to shut the charging unit down. In particular, the command may be for the charging unit to enter the idle or the sleep state.

In other examples, there may be no heartbeat 400 or heartbeat back 201 communications. In an embodiment, a single cover status signal may be sent from the charging unit controller to the device controller in response to the cover status changing, i.e. the cover being moved to the open or the closed position. A cover status signal may be sent from the charging unit controller to the device controller each and every time the cover status changes. The device controller may receive the cover status signal.

The device may comprise a memory which is configured to, in response to receiving a cover status signal, store a cover status indicator in the memory. For example, the device controller may receive a cover closed signal, and in response to receiving the cover closed signal, the memory may be configured to store a cover closed indicator in the memory.

In embodiments, the heartbeat communication may comprise information relating to the charging unit 101 and/or the aerosol provision device. It will be appreciated that the heartbeat communication may comprise any suitable information relating to the charging unit 101 and/or the aerosol provision device 100. In embodiments, the heartbeat communication may comprise information relating to the charging unit 101 and/or the aerosol provision device without comprising the cover status. In embodiments, the heartbeat communication may comprise information relating to the charging unit 101 and/or the aerosol provision device in addition to the cover status.

In the device wake up state 220, the device controller of the aerosol provision device 100 may monitor the battery level of the aerosol provision device 100 in order to check the voltage and/or power level of the battery of the aerosol provision device 100 in order to determine if the battery is sufficiently charged to start (but not necessarily complete) a session which may be initiated by the user.

The battery of the aerosol provision device 100 may be deemed sufficiently charged if it satisfies an acceptance threshold criterion. According to various embodiments the battery of the aerosol provision device 100 may comprise either a lithium iron phosphate (LiFePO₄) battery or a lithium titanate or lithium titanium oxide (LTO) battery. The battery of the aerosol provision device 100 may have a capacity when full charged in the range: (i) <50 mAh; (ii) 50-100 mAh; (iii) 100-150 mAh; or (iv) 150-200 mAh. According to various embodiments, the battery of the aerosol provision device 100 may be deemed to be sufficiently charged in order to at least commence a session of use if the determined current capacity of the battery exceeds a threshold which is within a range: (i) <20 mAh; (ii) 20-40 mAh; (iii) 40-60 mAh; (iv) 60-80 mAh; (v) 80-100 mAh; (vi) 100-120 mAh; (vii) 120-140 mAh; (viii) 140-160 mAh; (ix) 160-180 mAh; or (x) 180-200 mAh.

Once the session of use has ended 260 (e.g. the session cycle has ended, the user ends it, or the battery level is no longer sufficient), the device controller may return to the idle state 200.

The charging unit controller may be arranged to determine that the aerosol provision device 100 has is inserted into the receptacle of the charging unit 101 or if charging unit controller determined that the aerosol provision device 100 is subsequently inserted into the charging unit 101 and if the aerosol provision device is in an idle or sleep state, it may be charged by the charging unit.

The controller of the charging unit 101 may be arranged to check the battery level or the current capacity of the battery of the charging unit 101 and whether or not a charging cable (e.g. a USB cable) that may be connected to an external power source has been inserted into the charging unit 101.

If a charging cable has been inserted into the charging unit 101 whilst the charging unit 101 is not electrically connected to the aerosol provision device 100 (i.e. the aerosol provision device 100 is not inserted into the receptacle of the charging unit 1010) and wherein no session has been commenced then the battery of the charging unit 101 may be arranged to be charged by the external power supply.

When it is determined that the aerosol provision device 100 is electrically connected to the charging unit 101 (when the aerosol provision device is in the receptacle of the charging unit 101), the controller of the charging unit 101 may be arranged to check the battery energy or current capacity of the battery in the charging unit 101 and/or the battery in the aerosol provision device 100. If it is determined that the battery in the aerosol provision device 100 is below an acceptable threshold criterion, then the battery of the aerosol provision device 100 may be recharged via the charging cable. For example, the battery of the aerosol provision device 100 may have a capacity when fully charged in the range: (i) <50 mAh; (ii) 50-100 mAh; (iii) 100-150 mAh; or (iv) 150-200 mAh. According to various embodiments, the battery of the aerosol provision device 100 may be deemed to be below an acceptable threshold criterion and hence to need recharging if the determined current capacity of the battery is determined to be within a range: (i) <20 mAh; (ii) 20-40 mAh; (iii) 40-60 mAh; (iv) 60-80 mAh; (v) 80-100 mAh; (vi) 100-120 mAh; (vii) 120-140 mAh; (viii) 140-160 mAh; (ix) 160-180 mAh; or (x) 180-200 mAh.

In the situation wherein it is determined that the battery of the charging unit 101 is also below an acceptable threshold, then the battery of the charging unit 101 may also be recharged via the charging cable. The battery of the charging unit 101 may be charged simultaneously with the battery of the aerosol provision device 100. According to various embodiments electrical power from an external power source may be supplied in a pulsed manner to either the battery of the aerosol provision device 100 and/or the battery of the charging unit 100. According to an embodiment charging pulses may be supplied alternately between the aerosol provision device 100 and the charging unit 101 so that any specific point in time either the battery of the aerosol provision device 100 is being charged by the external power supply or alternatively the battery of the charging unit 101 is being charged by the external power supply so that the batteries of the aerosol provision device 100 and the charging unit 101 are not charged simultaneously. Embodiments are contemplated wherein the battery of the aerosol provision device 100 may be fully recharged before the battery of the charging unit 101 is fully recharged due to the battery of the aerosol provision device 100 having a lower capacity than that of the charging unit 101.

According to various embodiments the battery (or more generally the electrical energy storage device) of the charging unit 101 may comprise: (i) a lithium cobalt oxide (LiCoO₂) battery; (ii) a lithium manganese oxide (LiMn₂O₄) battery; (iii) a lithium nickel manganese cobalt oxide (LiNiₓMn_{y}CO_{z}O₂) battery; or (iv) a lithium nickel cobalt aluminium oxide (LiNiCoAlO₂) battery. According to various embodiments the battery of the charging unit 101 may be recharged by an external power supply if the determined capacity of the battery of the charging unit 101 is determined to be below a threshold, wherein the threshold is in the range: (i) 1000-1100 mAh; (ii) 1100-1200 mAh; (iii) 1100-1200 mAh; (iv) 1200-1300 mAh; (v) 1300-1400 mAh; (vi) 1400-1500 mAh; (vii) 1500-2000 mAh; or (viii) >2000 mAh.

According to embodiments the battery of the aerosol provision device 100 and the battery of the charging unit 101 may be charged individually, simultaneously, synchronously or asynchronously optionally via a charging cable or a wireless charging interface when the aerosol provision device 100 is inserted into the receptacle of the charging unit 101.

According to embodiments, if it is determined that the power level or current capacity of the battery of the aerosol provision device 100 is below an acceptable threshold criterion, then the battery of the aerosol provision device 100 may be charged via the battery of the charging unit 101.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision system comprising an aerosol provision device and a charging unit for charging the aerosol provision device, wherein the aerosol provision device comprises an aerosol generator, the aerosol generator configured to generate an aerosol from aerosol generating material,
wherein the charging unit comprises:
a receptacle for receiving the aerosol provision device;
a cover moveable between an open position and a closed position, the cover configured to cover at least a portion of the aerosol provision device when the cover is in the closed position; and
a charging unit controller configured to periodically send a heartbeat communication to the aerosol provision device, wherein the heartbeat communication comprises a cover status, the cover status indicative of whether the cover is in the open position or in the closed position.

2. The aerosol provision system of claim 1, wherein the charging unit controller is configured to send the heartbeat communication with a heartbeat period, wherein the heartbeat period is less than 1 s.

3. The aerosol provision system of claim 2, wherein the heartbeat period is approximately 200 ms.

4. The aerosol provision system of claim 1, wherein the aerosol provision device comprises a device controller, the device controller configured to receive the heartbeat communication and to send a heartbeat back communication to the charging unit controller in response to receiving the heartbeat communication.

5. The aerosol provision system of claim 4, wherein the heartbeat back communication comprises aerosol delivery device status information.

6. The aerosol provision system of claim 5, wherein the aerosol provision device comprises a device energy storage, the aerosol delivery device status information comprising a charge level of the device energy storage.

7. The aerosol provision system of claim 4, wherein the heartbeat back communication comprises a command.

8. The aerosol provision system of claim 7, wherein the command is to display a charge level of the charging unit energy storage.

9. The aerosol provision system of claim 7, wherein the command is to shut down the charging unit.

10. The aerosol provision system of claim 1 and comprising a user input element, the aerosol provision device comprising a device controller configured to control the aerosol provision device to enter an off state in response to the user providing an input to the user input element and the cover being in the closed position.

11. The aerosol provision device of claim 10, wherein activation of the aerosol generator is prevented when the aerosol provision device is in the off state.

12. The aerosol provision system according to claim 1, wherein the aerosol provision system comprises a controller configured to prevent activation of the aerosol generator when the cover is in the closed position.

13. The aerosol provision device according to claim 1, wherein the aerosol provision device is a tobacco heating product.

14. A charging unit for charging an aerosol provision device, the aerosol provision device comprising an aerosol generator, the aerosol generator configured to generate an aerosol from aerosol generating material, the charging unit comprising:
a receptacle for receiving the aerosol provision device;
a cover moveable between an open position and a closed position, the cover configured to cover at least a portion of the aerosol provision device when the cover is in the closed position; and
a charging unit controller configured to periodically send a heartbeat communication to the aerosol provision device, wherein the heartbeat communication comprises a cover status, the cover status indicative of whether the cover is in the open position or in the closed position.

15. A method of operating a charging unit for an aerosol provision device, the aerosol provision device comprising an aerosol generator, the aerosol generator configured to generate an aerosol from aerosol generating material, the charging unit comprising:
a receptacle for receiving the aerosol provision device;
a cover moveable between an open position and a closed position, the cover configured to cover at least a portion of the aerosol provision device when the cover is in the closed position,
the method comprising periodically sending a heartbeat communication to the aerosol provision device, wherein the heartbeat communication comprises a cover status, the cover status indicative of whether the cover is in the open position or in the closed position.
